(19) United States
(12) Patent Application Publication
(10) Pub. No.: US 2023/0108838 A1
(43) Pub. Date: Apr. 6, 2023

(54) SOFTWARE UPDATE SYSTEM AND METHOD FOR PROXY MANAGED HARDWARE DEVICES OF A COMPUTING ENVIRONMENT

(71) Applicant: Dell Products, L.P., Round Rock, TX (US)

(72) Inventors: Pushkala Iyer, Round Rock, TX (US); Prakash Nara, Austin, TX (US); Anoop Kumar Alladi, Georgetown, TX (US); Saranya Shanmugam, Kanata (CA)

(73) Assignee: Dell Products, L.P., Round Rock, TX (US)

(21) Appl. No.: 17/492,871

(22) Filed: Oct. 4, 2021

(51) Int. Cl. G06F 8/65; G06F 8/61; H04L 29/08

(52) U.S. Cl. CPC G06F 8/65; G06F 8/63; H04L 67/2833

(57) ABSTRACT

According to one embodiment, a software update system for an Information Handling System (IHS) with hardware components including at least one directly managed hardware component and multiple proxy managed hardware components that are managed by one or more controller devices. The software update system has computer-readable instructions for, in response to receiving a request to perform a software update on the hardware components, partitioning the directly managed hardware component from the proxy managed hardware components, grouping the proxy managed hardware components according to each of the controller devices, and generating an Application Program Interface (API) call that specifies the group associated with each of the controller devices. The software update system then sends the API call to the directly managed hardware component, wherein the directly managed hardware component is configured to communicate with each of the controller devices for updating the proxy managed hardware components according to the API call.

### FIELD

The present disclosure relates generally to Information Handling Systems (IHSs), and more particularly, to a software update system and method for proxy managed hardware devices of a computing environment.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition,

IHSs may include a variety of hardware and software components that may be configured to process, store, and communicate information and may include one or more computer systems, data storage systems, and networking systems.

Modern day computing resources are provided by large computing environments that may include server farms, computer clusters, individual computing devices, and/or data centers. Computing environments are generally associated with large organizations, such as business enterprises to educational institutions such as universities. In many cases, larger organizations may manage multiple server farms over a diverse geographical region. Nevertheless, management of such large, diversified computing environments are typically provided by a remotely configured system management console. OpenManage Enterprise is one example of a system management console provided by Dell Technologies, which cost-effectively facilitates comprehensive lifecycle management for the computing devices of distributed computing environments from one console.

A typical computing environment has physical rack or chassis structures with attendant power and communication connections. Such racks may hold multiple hardware components that may be swapped in and out of the rack. These racks may also include one or more chassis that has side walls joined by a bottom wall and a top wall. The rack may also include various electronic support components that may be used to support devices that are installed in the rack. For example, a rack system may include a power distribution board that includes power supply units to supply power to the devices in the rack. Additionally, a bus bar may be provided to provide support for cables to direct power from the power supply units to the devices in the rack.

Once installed, each shelf may hold different hardware components. Different hardware components such as servers, switches, routers, and the like are often housed in removable sled structures that may be inserted on one of the shelves in the rack. The size of these sled components is based in standard height units. For example, height may be expressed in terms of “U”. Thus a standard 1U rack-mount server is 1.75 inches high, and a 2U server measures three inches in height. Additionally, typical hardware components may be designed with different standard units of height.

### SUMMARY

According to one embodiment, a software update system for an Information Handling System (IHS) with hardware components including at least one directly managed hardware component and multiple proxy managed hardware components that are managed by one or more controller devices. The software update system has computer-readable instructions for, in response to receiving a request to perform a software update on the hardware components, partitioning the directly managed hardware component from the proxy managed hardware components, grouping the proxy managed hardware components according to each of the controller devices, and generating an Application Program Interface (API) call that specifies the group associated with each of the controller devices. The software update system then sends the API call to the directly managed hardware component, wherein the directly managed hardware component is configured to communicate with each of the controller devices for updating the proxy managed hardware components according to the API call.

According to another embodiment, a method includes the step of receiving a request to perform a software update on multiple hardware components including at least one directly managed hardware component, multiple proxy managed hardware components managed by one or more controller devices. The method further includes the steps of partitioning the directly managed hardware component from the proxy managed hardware components, grouping the proxy managed hardware components according to each of the controller devices that directly manages the proxy managed components, and generating an Application Program Interface (API) call that specifies the group associated with each of the controller devices. Each group comprises a unique identifier (UID) for each proxy managed hardware component directly managed by its respective controller device. The method then sends the API call to the directly managed hardware component, wherein the directly managed hardware component is configured to communicate with each of the controller devices for updating the proxy managed hardware components according to the API call.

According to yet another embodiment, a systems manager appliance includes computer-readable instructions that are configured to receive a request to perform a software update on a plurality of hardware components comprising at least one directly managed hardware component and a plurality of proxy managed hardware components managed by one or more controller devices, partition the directly managed hardware component from the proxy managed hardware components, group the proxy managed hardware components according to each of the controller devices that directly manages the proxy managed components, and generate an Application Program Interface (API) call that specifies the group associated with each of the controller devices. The systems manager appliance then sends the API call to the directly managed hardware component in which the directly managed hardware component is configured to communicate with each of the controller devices for updating the proxy managed hardware components according to the API call.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a block diagram illustrating certain components of a chassis comprising one or more compute sleds and one or more storage sleds that may be configured to provide a software update system according to one embodiment of the present disclosure.

FIG. 2 shows an example of an IHS configured to provide the software update system according to one embodiment of the present disclosure.

FIG. 3 is a diagram view illustrating several components of an example software update system according to one embodiment of the present disclosure.

FIG. 4 illustrates an example software update method that may be performed to perform a software update on various hardware components of a computing environment that includes one or more proxy monitored hardware components according to one embodiment of the present disclosure.

FIG. 5 illustrates an example status window that may be generated by the systems manager to display a status of a software update operation performed on a computing environment according to one embodiment of the present disclosure.

### DETAILED DESCRIPTION

Embodiments of the present disclosure provide an efficient software updating system and method for proxy managed hardware components of a computing environment. Many large, modern computing environments, such as data centers, are managed by systems that do not possess direct control over all of the hardware components of the computing environment, such as when proxy managed hardware components are used. This characteristic may be particularly problematic when software updates are to be periodically implemented on those devices. Embodiments of the present disclosure provide a solution to this problem, among others, by implementing a system that groups the proxy managed hardware components of a computing environment according to its controller device so that each of the hardware components may updated at or near the same time using a single update package image. Additionally, the update request may be provided as a single Applications Program Interface (API) command in which some, most, or all of the hardware components of the computing environment may commence their respective update procedures at the same time to setup or download their appropriate software update packages. Once the setup of the software update procedures has been successfully accomplished, an ensuing trigger request may be performed so that the hardware components can be loaded with their respective software update packages at or near the same time.

Management of a large, diversified computing environment is typically provided by a remotely configured system management console. OpenManage Enterprise is one example of a systems manager provided by Dell Technologies, which cost-effectively facilitates comprehensive lifecycle management for the computing devices of distributed computing environments from a single console. While such systems management consoles have been an effective tool for remotely managing a computing environment, their use with relatively large numbers of computing devices can sometimes be unwieldy. In many cases, for example, currently implemented computing environments, such as one implemented with a MX-7000 computing chassis provided by Dell Technologies, may include certain hardware components (e.g., sleds that are managed indirectly via a controller device configured in that sled). Within this disclosure, the chassis is considered to be a proxy and the hardware components that are indirectly managed thereby are considered to be proxy managed hardware components.

With such structures, systems managers often encounter several problems, such as an inherent difficulty in updating most or all of the proxy managed hardware components in a timely manner, particularly when the chassis has been scaled (e.g., expanded to include multiple chassis). For example, chassis, such as the MX-7000 described herein above, may be scaled to include twenty MX-7000 chassis using a daisy chain-like management architecture in which one of the MX-7000 chassis functions as a principal management interface, that in turn, relays management instructions to the other nineteen MX-7000 chassis. Because each MX-7000 may be configured with eight sleds thus yielding a scaled structure with 160 sleds each with proxy managed hardware components, it would be functionally difficult, if not possible, to update all of them at one time and/or within a fixed maintenance window often imposed by data center managers.

Additionally, conventional systems managers have not supported separate setup and trigger operations for their software update procedures. The setup operation generally refers to the acts of identifying an appropriate software update image for each hardware component, and downloading that software update image or otherwise acquiring the software update image from an appropriate source. The trigger operation, on the other hand generally refers to the acts of commencing the software update process by loading or installing the downloaded software update image on its associated hardware component. It would be beneficial, for example, to perform the setup operation during a first time period, such as when the chassis is in normal service mode, and perform the trigger operation during a second time period, such as a maintenance window, which in many cases, is relatively short. Embodiments of the present disclosure provide a solution to these problems, among others, by implementing a system and method that groups the proxy managed hardware components of a computing environment according to its controller device so that each of the hardware components may updated at or near the same time using a single update package image as will be described in detail herein below.

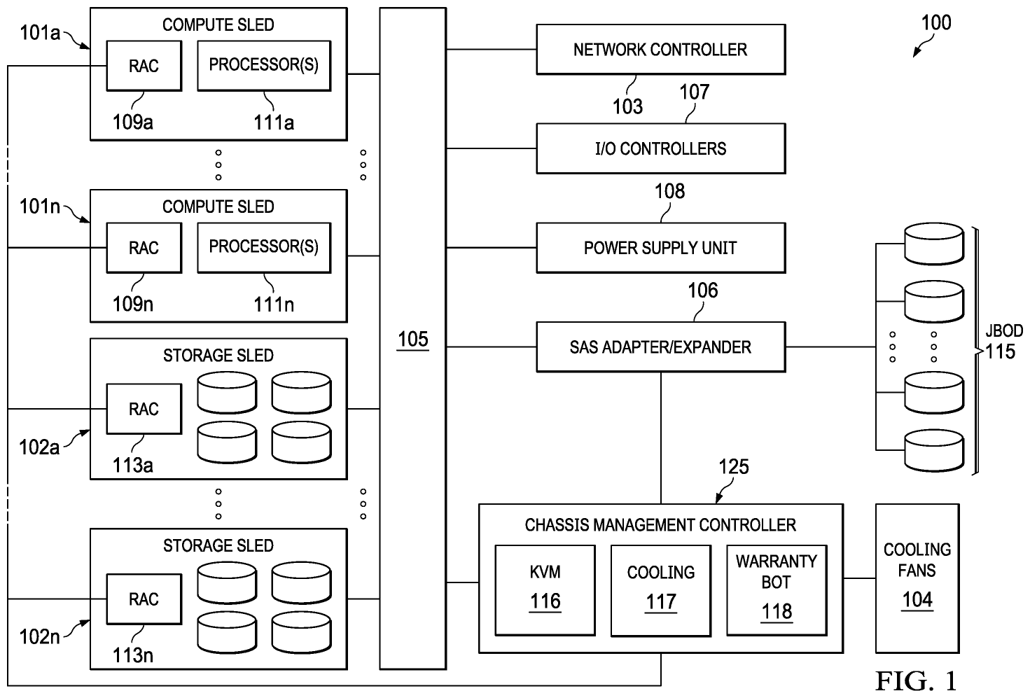

FIG. 1 is a block diagram illustrating certain components of a chassis 100 comprising one or more compute sleds 101a-n and one or more storage sleds 102a-n that may be configured to implement the systems and methods described herein. As described in additional detail below, each of the sleds 101a-n, 102a-n may be separately licensed hardware components and each of the sleds may also operate using a variety of licensed hardware and software features. Chassis 100 may include one or more bays that each receive an individual sled (that may be additionally or alternatively referred to as a tray, blade, and/or node), such as compute sleds 101a-n and storage sleds 102a-n. Chassis 100 may support a variety of different numbers (e.g., 4, 8, 16, 32), sizes (e.g., single-width, double-width), and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

By configuring a chassis 100 with different sleds, the chassis may be adapted to support specific types of operations, thus providing a computing solution that is directed toward a specific type of computational task. For instance, a chassis 100 that is configured to support artificial intelligence computing solutions may include additional compute sleds, compute sleds that include additional processors, and/or compute sleds that include specialized artificial intelligence processors or other specialized artificial intelligence components, such as specialized FPGAs. In another example, a chassis 100 configured to support specific data mining operations may include network controllers 103 that support high-speed couplings with other similarly configured chassis, thus supporting high-throughput, parallel-processing computing solutions.

In another example, a chassis 100 configured to support certain database operations may be configured with specific types of storage sleds 102a-n that provide increased storage space or that utilize adaptations that support optimized performance for specific types of databases. In other scenarios, a chassis 100 may be configured to support specific enterprise applications, such as by utilizing compute sleds 101a-n and storage sleds 102a-n that include additional memory resources that support simultaneous use of enterprise applications by multiple remote users. In another example, a chassis 100 may include compute sleds 101a-n and storage sleds 102a-n that support secure and isolated execution spaces for specific types of virtualized environments. In some instances, specific combinations of sleds may comprise a computing solution, such as an artificial intelligence system, that may be licensed and supported as a computing solution.

Multiple chassis 100 may be housed within a rack. Data centers may utilize large numbers of racks, with various different types of chassis installed in the various rack configurations. The modular architecture provided by the sleds, chassis, and rack allow for certain resources, such as cooling, power, and network bandwidth, to be shared by the compute sleds 101a-n and the storage sleds 102a-n, thus providing efficiency improvements, and supporting greater computational loads.

Chassis 100 may be installed within a rack structure that provides all or part of the cooling utilized by chassis 100. For airflow cooling, a rack may include one or more banks of cooling fans that may be operated to ventilate heated air away from a chassis 100 that is housed within a rack. Chassis 100 may alternatively or additionally include one or more cooling fans 104 that may be similarly operated to ventilate heated air from within the sleds 101a-n, 102a-n installed within the chassis. A rack and a chassis 100 installed within the rack may utilize various configurations and combinations of cooling fans 104 to cool the sleds 101a-n, 102a-n and other components housed within chassis 100.

Sleds 101a-n, 102a-n may be individually coupled to chassis 100 via connectors. The connectors may correspond to bays provided in the chassis 100 and may physically and electrically couple an individual sled 101a-n, 102a-n to a backplane 105. Chassis backplane 105 may be a printed circuit board that includes electrical traces and connectors that are configured to route signals between the various components of chassis 100. In various embodiments, backplane 105 may include various additional components, such as cables, wires, midplanes, backplanes, connectors, expansion slots, and multiplexers. In certain embodiments, backplane 105 may be a motherboard that includes various electronic components installed thereon. In some embodiments, components installed on a motherboard-type backplane 105 may include components that implement all or part of the functions described with regard to components such as network controller 103, SAS (Serial Attached SCSI) adapter/expander 106, I/O controllers 107, and power supply unit 108.

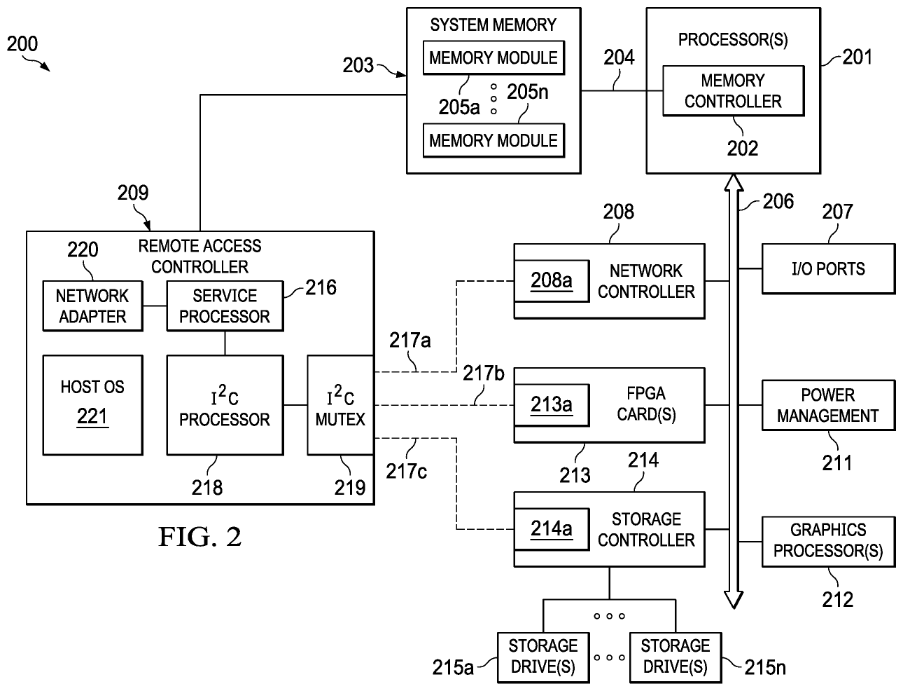

In certain embodiments, a compute sled 101a-n may be an IHS, such as described with regard to IHS 200 of FIG. 2. A compute sled 101a-n may provide computational processing resources that may be used to support a variety of e-commerce, multimedia, business, and scientific computing applications. In some cases, these applications may be provided as services via a cloud implementation. Compute sleds 101a-n are typically configured with hardware and software that provide leading-edge computational capabilities. Accordingly, services provided using such computing capabilities are typically provided as high-availability systems that operate with minimum downtime. Compute sleds 101a-n may be configured for general-purpose computing or may be optimized for specific computing tasks in support of specific computing solutions. A compute sled 101a-n may be a licensed component of a data center and may also operate using various licensed hardware and software systems.

As illustrated, each compute sled 101a-n includes a remote access controller (RAC) 109a-n. As described in additional detail with regard to FIG. 2, a remote access controller 109a-n provides capabilities for remote monitoring and management of each compute sled 101a-n. In support of these monitoring and management functions, remote access controllers 109a-n may utilize both in-band and sideband (i.e., out-of-band) communications with various internal components of a compute sled 101a-n and with other components of chassis 100. Remote access controller 109a-n may collect sensor data, such as temperature sensor readings, from components of the chassis 100 in support of airflow cooling of the chassis 100 and the sleds 101a-n, 102a-n. Also as described in additional detail with regard to FIG. 2, remote access controllers 109a-n may support communications with chassis management controller 110 where these communications may report on the status of hardware and software systems on a particular sled 101a-n, 102a-n, such as information regarding warranty coverage for a particular hardware and/or software system.

A compute sled 101a-n may include one or more processors 111a-n that support specialized computing operations, such as high-speed computing, artificial intelligence processing, database operations, parallel processing, graphics operations, streaming multimedia, and/or isolated execution spaces for virtualized environments.

Using such specialized processor capabilities of a compute sled 101a-n, a chassis 100 may be adapted for a particular computing solution.

In some embodiments, each compute sled 101a-n may include a storage controller that may be utilized to access storage drives that are accessible via chassis 100. Some of the individual storage controllers may provide support for RAID

(Redundant Array of Independent Disks) configurations of logical and physical storage drives, such as storage drives provided by storage sleds 102a-n. In some embodiments, some or all of the individual storage controllers utilized by compute sleds 101a-n may be HBAs (Host Bus Adapters) that provide more limited capabilities in accessing physical storage drives provided via storage sleds 102a-n and/or via SAS expander 106.

As illustrated, chassis 100 also includes one or more storage sleds 102a-n that are coupled to the backplane 105 and installed within one or more bays of chassis 100 in a similar manner to compute sleds 101a-n. Each of the individual storage sleds 102a-n may include various different numbers and types of storage devices. For instance, storage sleds 102a-n may include SAS (Serial Attached SCSI) magnetic disk drives, SATA (Serial Advanced Technology Attachment) magnetic disk drives, solid-state drives (SSDs), and other types of storage drives in various combinations. The storage sleds 102a-n may be utilized in various storage configurations by the compute sleds 101a-n that are coupled to chassis 100. As illustrated, each storage sled 102a-n may include a remote access controller (RAC) 113a-n. Remote access controllers 113a-n may provide capabilities for remote monitoring and management of storage sleds 102a-n in a similar manner to the remote access controllers 109a-n in compute sleds 101a-n.

In addition to the data storage capabilities provided by storage sleds 102a-n, chassis 100 may provide access to other storage resources 115 that may be installed as components of chassis 100 and/or may be installed elsewhere within a rack housing the chassis 100, such as within a storage blade. In certain scenarios, storage resources 115 may be accessed via SAS expander 106 that is coupled to backplane 105 of chassis 100. For example, SAS expander 106 may support connections to a number of

JBOD (Just a Bunch Of Disks) storage drives 115 that may be configured and managed individually and without implementing data redundancy across the various drives 115. The additional storage resources 115 may also be at various other locations within the data center in which chassis 100 is installed. Such additional storage resources 115 may also be remotely located from chassis 100.

As illustrated, the chassis 100 of FIG. 1 includes a network controller 103 that provides network access to the sleds 101a-n, 102a-n installed within the chassis. Network controller 103 may include various switches, adapters, controllers, and couplings used to connect chassis 100 to a network, either directly or via additional networking components and connections provided via a rack in which chassis 100 is installed. In some embodiments, network controllers 103 may be replaceable components that include capabilities that support certain computing solutions, such as network controllers 103 that interface directly with network controllers from other chassis in support of clustered processing capabilities that utilize resources from multiple chassis.

Chassis 100 may also include a power supply unit 108 that provides the components of the chassis with various levels of DC power from an AC power source or from power delivered via a power system provided by the rack within which chassis 100 is installed. In certain embodiments, power supply unit 108 may be implemented within a sled that may provide chassis 100 with redundant, hot-swappable power supply units. In such embodiments, power supply unit 108 is a replaceable component that may be used in support of certain computing solutions.

Chassis 100 may also include various I/O controllers 107 that may support various I/O ports, such as USB ports that may be used to support keyboard and mouse inputs and/or video display capabilities. I/O controllers 107 may be utilized by a chassis management controller 110 to support various KVM (Keyboard, Video and Mouse) 116 capabilities that provide administrators with the ability to interface with the chassis 100.

In addition to providing support for KVM 116 capabilities for administering chassis 100, chassis management controller 110 may support various additional functions for sharing the infrastructure resources of chassis 100. In some scenarios, chassis management controller 110 may implement tools for managing the network bandwidth 103, power 108, and airflow cooling 104 that are available via the chassis 100. As described, the airflow cooling 104 utilized by chassis 100 may include an airflow cooling system that is provided by a rack in which the chassis 100 may be installed and managed by a cooling module 117 of the chassis management controller 110.

As described, components of chassis 100 such as compute sleds 101a-n and storage sleds 102a-n may include remote access controllers 109a-n, 113a-n that may collect information regarding the warranties for hardware and software systems on each sled. Chassis management controller 110 may similarly collect and report information regarding the warranties for hardware and software systems on each sled.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail with respect to FIG. 2.

IHSs 107a-d may be used to support a variety of e-commerce, multimedia, business, and scientific computing applications. In some cases, these applications may be provided as services via a cloud implementation. IHSs 107a-d are typically configured with hardware and software that provide leading-edge computational capabilities. IHSs 107a-d may also support various numbers and types of storage devices. Accordingly, services provided using such computing capabilities are typically provided as high-availability systems that operate with minimum downtime. The warranties provided by vendors of IHSs 107a-d and the related hardware and software allow the data centers 101a-d to provide contracted Service Level Agreement (SLA) to customers. Upon failure of an IHS 107a-d, data centers 101a-d and operations center 102 typically relies on a vendor to provide warranty support in order to maintain contracted SLAs.

FIG. 2 illustrates an example IHS 200 configured to implement the systems and methods described herein. It should be appreciated that although the embodiments described herein may describe an IHS that is a compute sled or similar computing component that may be deployed within the bays of a chassis, other embodiments may be utilized with other types of IHSs. In the illustrative embodiment of FIG. 2, IHS 200 may be a computing component, such as compute sled 101a-n, that is configured to share infrastructure resources provided by a chassis 100 in support of specific computing solutions.

IHS 200 may be a compute sled that is installed within a large system of similarly configured IHSs that may be housed within the same chassis, rack and/or data center. IHS 200 may utilize one or more processors 201. In some embodiments, processors 201 may include a main processor and a co-processor, each of which may include a plurality of processing cores that, in certain scenarios, may each be used to run an instance of a server process. In certain embodiments, one, some or all processor 201 may be graphics processing units (GPUs). In some embodiments, one, some or all processor 201 may be specialized processors, such as artificial intelligence processors or processor adapted to support high-throughput parallel processing computations. As described, such specialized adaptations of IHS 200 may be used to implement specific computing solutions support by the chassis in which IHS 200 is installed.

As illustrated, processor 201 includes an integrated memory controller 202 that may be implemented directly within the circuitry of the processor 201, or memory controller 202 may be a separate integrated circuit that is located on the same die as the processor 201. Memory controller 202 may be configured to manage the transfer of data to and from a system memory 203 of the IHS 201 via a high-speed memory interface 204.

System memory 203 is coupled to processor 201 via a memory bus 204 that provides the processor 201 with high-speed memory used in the execution of computer program instructions by the processor 201. Accordingly, system memory 203 may include memory components, such as such as static RAM (SRAM), dynamic RAM (DRAM), or NAND Flash memory, suitable for supporting high-speed memory operations by the processor 201. In certain embodiments, system memory 203 may combine both persistent, non-volatile memory, and volatile memory.

In certain embodiments, system memory 203 may be comprised of multiple removable memory modules. System memory 203 in the illustrated embodiment includes removable memory modules 205a-n. Each of the removable memory modules 205a-n may correspond to a printed circuit board memory socket that receives a removable memory module 205a-n, such as a DIMM (Dual In-line Memory Module), that can be coupled to the socket and then decoupled from the socket as needed, such as to upgrade memory capabilities or to replace faulty components. Other embodiments of IHS system memory 203 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 201. All or portions of the chipset may be implemented directly within the integrated circuitry of an individual processor 201. The chipset may provide the processor 201 with access to a variety of resources accessible via one or more buses 206. Various embodiments may utilize any number of buses to provide the illustrated pathways served by bus 206. In certain embodiments, bus 206 may include a PCIe (PCI Express) switch fabric that is accessed via a PCIe root complex. IHS 200 may also include one or more I/O ports 207, such as PCIe ports, that may be used to couple the IHS 200 directly to other IHSs, storage resources or other peripheral components. In certain embodiments, the I/O ports 207 may provide couplings to the backplane of the chassis in which the IHS 200 is installed.

As illustrated, a variety of resources may be coupled to the processor 201 of the IHS 200 via bus 206. For instance, processor 201 may be coupled to a network controller 208, such as provided by a Network Interface Controller (NIC) that is coupled to the IHS 200 and allows the IHS 200 to communicate via an external network, such as the Internet or a LAN. As illustrated, network controller 208 may report information to a remote access controller 209 via an out-of-band signaling pathway that is independent of the operating system of the IHS 200.

Processor 201 may also be coupled to a power management unit 211 that may interface with power system unit 108 of chassis 100 in which an IHS 200, such as a compute sled 101a-n, may be installed. In certain embodiments, a graphics processor 212 may be comprised within one or more video or graphics cards, or an embedded controller, installed as components of IHS 200. In certain embodiments, graphics processor 212 may be an integrated of the remote access controller 209 and may be utilized to support the display of diagnostic and administrative interfaces related to IHS 200 via display devices that are coupled, either directly or remotely, to remote access controller 209.

As illustrated, IHS 200 may include one or more FPGA (Field-Programmable Gate Array) card(s) 213. Each of the FPGA cards 213 supported by IHS 200 may include various processing and memory resources, in addition to an FPGA integrated circuit that may be reconfigured after deployment of IHS 200 through programming functions supported by FPGA card 213. Each individual FGPA card 213 may be optimized to perform specific processing tasks, such as specific signal processing, security, data mining, and artificial intelligence functions, and/or to support specific hardware coupled to IHS 200. In certain embodiments, such specialized functions supported by an FPGA card 213 may be utilized by IHS 200 in support of certain computing solutions. As illustrated, FPGA 213 may report information to the remote access controller 209 via an out-of-band signaling pathway that is independent of the operating system of the IHS 200.

IHS 200 may also support one or more storage controllers 214 that may be utilized to provide access to virtual storage configurations. For instance, storage controller 214 may provide support for RAID (Redundant Array of Independent Disks) configurations of storage devices 215a-n, such as storage drives provided by storage sleds 102a-n and/or JBOD 115 of FIG. 1. In some embodiments, storage controller 214 may be an HBA (Host Bus Adapter). Storage controller 214 may report information to the remote access controller 209 via an out-of-band signaling pathway that is independent of the operating system of the IHS 200.

In certain embodiments, IHS 200 may operate using a BIOS (Basic Input/Output System) that may be stored in a non-volatile memory accessible by the processor(s) 201. The BIOS may provide an abstraction layer by which the operating system of the IHS 200 interfaces with the hardware components of the IHS. Upon powering or restarting IHS 200, processor 201 may utilize BIOS instructions to initialize and test hardware components coupled to the IHS, including both components permanently installed as components of the motherboard of IHS 200, and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 209.

In certain embodiments, remote access controller 209 may operate from a different power plane from the processors 201 and other components of IHS 200, thus allowing the remote access controller 209 to operate, and management tasks to proceed, while the processing cores of IHS 200 are powered off. As described, various functions provided by the BIOS, including launching the operating system of the IHS 200, may be implemented by the remote access controller 209. In some embodiments, the remote access controller 209 may perform various functions to verify the integrity of the IHS 200 and its hardware components prior to initialization of the IHS 200 (i.e., in a bare-metal state).

Remote access controller 209 may include a service processor 216, or specialized microcontroller, that operates management software that supports remote monitoring and administration of IHS 200. Remote access controller 209 may be installed on the motherboard of IHS 200 or may be coupled to IHS 200 via an expansion slot provided by the motherboard. In support of remote monitoring functions, network adapter 208c may support connections with remote access controller 209 using wired and/or wireless network connections via a variety of network technologies.

In some embodiments, remote access controller 209 may support monitoring and administration of various devices 208, 213, 214 of an IHS via a sideband interface. In such embodiments, the messages in support of the monitoring and management function may be implemented using MCTP (Management Component Transport Protocol) that may be transmitted using I2C sideband bus connections 217a-c established with each of the respective managed devices 208, 213, 214. As illustrated, the managed hardware components of the IHS 200, such as FPGA cards 213, network controller 208 and storage controller 214, are coupled to the IHS processor 201 via an in-line bus 206, such as a PCIe root complex, that is separate from the I2C sideband bus connection 217a-c.

In certain embodiments, the service processor 216 of remote access controller 209 may rely on an I2C co-processor 218 to implement sideband I2C communications between the remote access controller 209 and managed components 208, 213, 214 of the IHS. The I2C co-processor 218 may be a specialized co-processor or micro-controller that is configured to interface via a sideband I2C bus interface with the managed hardware components 208, 213, 214 of IHS. In some embodiments, the I2C co-processor 218 may be an integrated component of the service processor 216, such as a peripheral system-on-chip feature that may be provided by the service processor 216. Each I2C bus 217a-c is illustrated as single line in FIG. 2. However, each I2C bus 217a-c may be comprised of a clock line and data line that couple the remote access controller 209 to I2C endpoints 208a, 213a, 214a.

As illustrated, the I2C co-processor 218 may interface with the individual managed devices 208, 213, and 214 via individual sideband I2C buses 217a-c selected through the operation of an I2C multiplexer 219. Via switching operations by the I2C multiplexer 219, a sideband bus connection 217a-c may be established by a direct coupling between the I2C co-processor 218 and an individual managed device 208, 213, or 214.

In providing sideband management capabilities, the I2C co-processor 218 may each interoperate with corresponding endpoint I2C controllers 208a, 213a, 214a that implement the I2C communications of the respective managed devices 208, 213, 214. The endpoint I2C controllers 208a, 213a, 214a may be implemented as a dedicated microcontroller for communicating sideband I2C messages with the remote access controller 209, or endpoint I2C controllers 208a, 213a, 214a may be integrated SoC functions of a processor of the respective managed device endpoints 208, 213, 214.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor 201 as a systems-on-a-chip.

In some embodiments, the remote access controller 209 may include or may be part of a baseboard management controller (BMC). As a non-limiting example of a remote access controller 209, the integrated Dell Remote Access Controller (iDRAC) from Dell® is embedded within Dell PowerEdge™ servers and provides functionality that helps information technology (IT) administrators deploy, update, monitor, and maintain servers remotely. In other embodiments, chassis management controller 110 may include or may be an integral part of a baseboard management controller. Remote access controller 209 may be used to monitor, and in some cases manage computer hardware components of IHS 200. Remote access controller 209 may be programmed using a firmware stack that configures remote access controller 209 for performing out-of-band (e.g., external to a computer's operating system or BIOS) hardware management tasks. Remote access controller 209 may run a host operating system (OS) 221 on which various agents execute. The agents may include, for example, a service module 250 that is suitable to interface with remote access controller 209 including, but not limited to, an iDRAC service module (iSM).

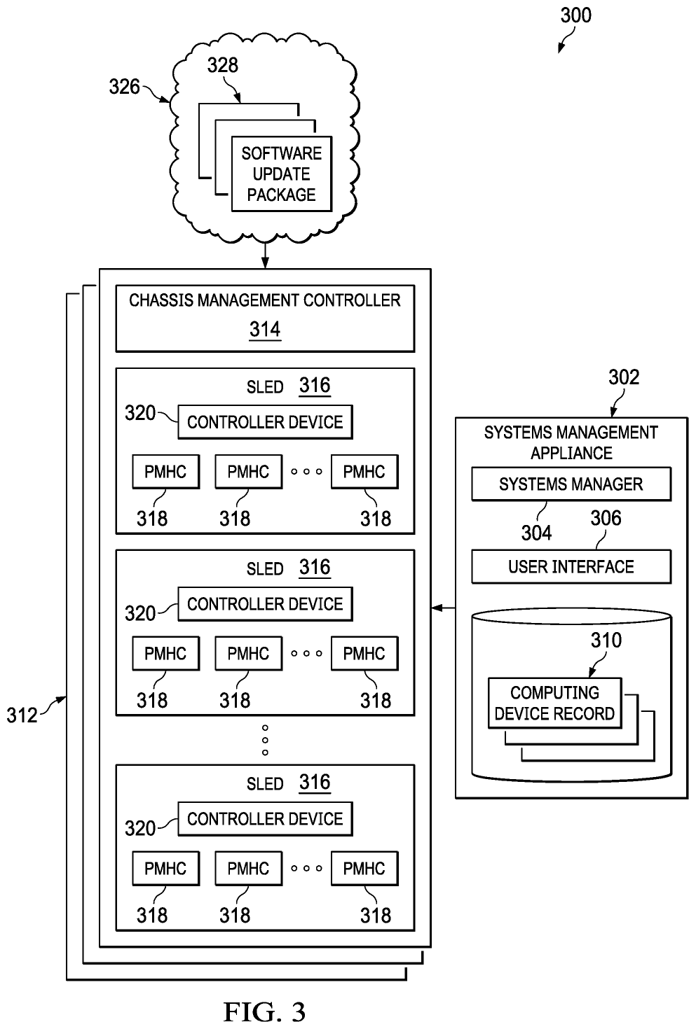

FIG. 3 is a diagram view illustrating several components of an example software update system 300 according to one embodiment of the present disclosure. The software update system 300 includes a systems management appliance 204 that manages the operation of a computing environment, which in this particular embodiment, is a stacked (e.g., scaled) computing chassis comprising multiple, individual chassis 312. Each chassis 312 is configured with a chassis management controller 314 and one or more sleds 316, which may be similar in design and construction to the chassis management controller 125 and sleds 105, 115 as described above with reference to FIG. 1. Each sled 316 may be configured with a controller device 320 and one or more proxy managed hardware components (PMHC) 318 that are directly controlled by its associated controller device 320. In one embodiment, controller device 320 may be similar in design and construction to the RAC 120 as described above with reference to FIG. 1.

The systems management appliance 204 includes a systems manager 304, a user interface 306, and a storage device 308. The systems manager 304 monitors and controls the operation of the chassis 312 via a chassis management controller 314. In one embodiment, systems manager 304 includes at least a portion of the Dell EMC OpenManage Enterprise (OME) that is installed on a secure virtual machine (VM), such as a VMWARE Workstation. Storage device 308 stores hardware component records 310 each associated with a hardware component in the computing environment 302. Each hardware component record 310 includes information about its associated hardware component in the chassis 312.

Whereas the systems manager 304 directly controls the operation of the chassis management controller 314, it may not possess the ability to directly control the operation of the various proxy monitored hardware components 318 configured in the sleds 316. Rather, the systems manager 304 controls the operation of the proxy monitored hardware components 318 indirectly through their respective controller devices 320. As such, the chassis is considered to be a proxy and the hardware components that are indirectly managed thereby are considered to be proxy managed hardware components. Such an architecture utilizing proxy monitored hardware components 318 may be problematic when updates are provided. For example, because each chassis 312 may be configured with multiple sleds each having multiple proxy monitored hardware components 318, it could be functionally difficult, if not possible, to update all of them at one time and/or within a fixed maintenance window often imposed by data center managers. For example, if the chassis and one of the sleds 316 share the same login credentials, the systems manager 204 can make a direct connection (e.g., WS-Man connection, etc.) to the one sled 316, thus providing for more complete management. However, if the chassis 312 and sled 316 have different login credentials, then the one sled 316 may only be managed indirectly through the controller device 316; that is, the sled 316 is proxied. Additionally, in a stacked configuration including multiple chassis 312, only the first main chassis 312 may be directly controlled via the chassis management controller 314, the other member chassis 312 in the stacked configuration along with their respective hardware components would also be proxied.

To address and fix certain issues and/or for enhancing functionality of such computing environments, software package updates are provided from time to time. In many cases, software package updates 328 may be provided by an online support portal 326, which is made available to customers by the IHS provider. For example, the DELL CORPORATION, which is headquartered in Round Rock, Tex., has an online support portal for distributing software packages that are packaged as Dell Update Packages (DUPs) (e.g., a particular type of Management Update package (MUP)). These MUPs encapsulate software package updates along with certain support data and scripts, such as software package metadata, applicability checking features, dependency checking features, and the like. In some cases, the MUPs are packaged into a single file that self-extracts from an archive file format (e.g., zip file), and applies (installs) the software package update when downloaded and executed in an operating system.

According to embodiments of the present disclosure, when a user selects a set of several hardware components for update, the systems manager 304 first determines the proxied devices in the set. The proxy monitored hardware components 318 are further grouped according to their respective controller device 316. For all proxy monitored hardware components 318 managed by one controller 316, the software update is provided by a single API call specifying a set of tuples that may be in the form of: {<component1, {targets}>, <component2, {targets}, . . . }. Here, the terms ‘component1’ and ‘component2’ refer to a particular make and model of hardware components, while ‘targets’ refers to a unique identifier of each hardware component. When the controller device 316 receives such an API call, it does not need to download a software update package 328 for each target; rather, it can download a single software update package 328 for all proxy monitored hardware components 318 that it directly controls, thus reducing any concern with limited storage space.

The API call as described above may also provide for device-type specific advanced options (e.g., clear prior jobs, reset device after update, setting changes, etc.).

In one embodiment, the hardware components of the chassis 312 may, when receiving the API call, perform the update in at least two different operations, namely a setup operation and a trigger operation. The setup operation involves the acts of identifying the software update image for each hardware component, and downloading that software update image from an appropriate source, such as the online support portal 326. The trigger operation generally involves the acts of performing the software update process by installing the downloaded software update image on its associated hardware component. Such operations may provide for identical presentation for execution history regardless of whether the updated hardware components are “direct” or “proxied” devices in some embodiments. That is, the status of the software update for each affected hardware component may be easily monitored as well as tracked over time.

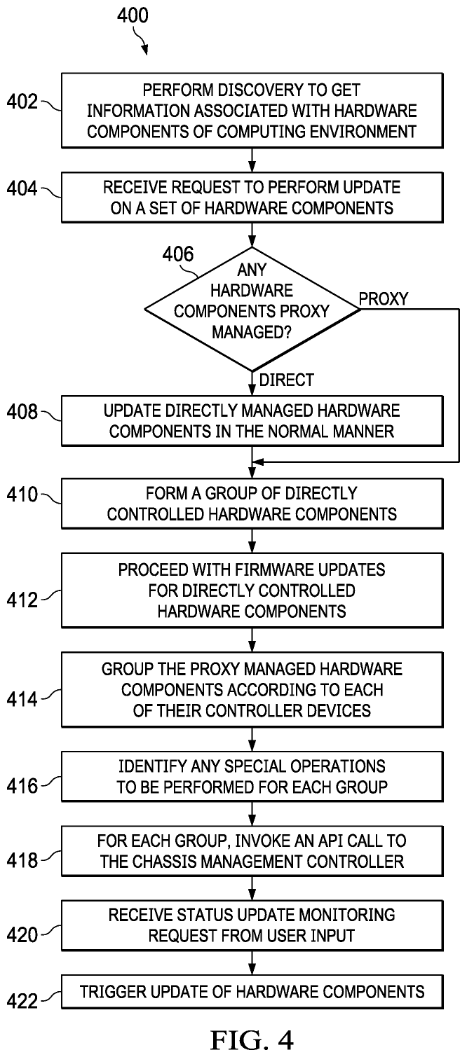

FIG. 4 illustrates an example software update method 400 that may be performed to perform a software update on various hardware components of a computing environment that includes one or more proxy monitored hardware components according to one embodiment of the present disclosure. In one embodiment, the software update method 400 may be performed in whole, or in part, by the systems manager 304 described herein above. Initially at step 402, the software update method 400 performs a discovery operation to update the hardware component records 310 stored in the systems management appliance 204.

In one embodiment, the software update method 400 may be performed as a separate setup operation in which the software update packages 328 are identified and downloaded from the online support portal 326, and a trigger operation in which the downloaded software update packages 328 are installed on their respective hardware components. For example, steps 404-418 describe certain steps that may be performed as part of the setup operation, while step 422 describes the trigger operation. It should be important to note that step 420 described herein below may be performed at any time during either the setup operation and/or the trigger operation.

At step 404, the method 400 receives a request to perform update on a set of hardware components of the computing environment, such as the chassis 312 or a stacked chassis comprising multiple chassis 312. Thereafter at step 406, the method 400 determines whether any hardware components are proxy monitored hardware components. If not, processing continues at step 408 to update the directly managed hardware components in the normal manner. Otherwise, processing continues at step 410.

At step 410, the method 400 forms a group including the directly controlled hardware components in the set of hardware components slated to be updated, and proceeds with firmware updates for the group of directly controlled hardware components at step 412. At step 414, the method 400 groups the proxy managed hardware components according to each of their controller devices. For example, the systems manager may examine the hardware component records 310 that were generated as a result of the discovery operation previously performed to identify those proxy monitored hardware components along with the controller device that manages their operation.

At step 416, the method 400 identifies any special operations to be performed for each group. For example, certain storage proxy monitored hardware components may require that a defragment operation be performed prior to being updated. As another example, a compute proxy monitored hardware components may require that a specified preparation script be performed to adjust certain settings after the update operation has been performed. For each of these example cases, the method 400 may identify for each of these example cases from any suitable source. For example, the method 400 may identify those special operations to be performed according to user input received from the user, or from information stored in the hardware component records 310.

At step 418, the method invokes an API call to the chassis management controller for each group generated at step 414. In one embodiment, the API call includes information associated with an identity of the proxy monitored hardware components, an identity of the controller device, and the special operations to be performed on those proxy monitored hardware components identifies at step 416. In one embodiment, the controller device may be a member chassis such that it would also be considered to be a proxied hardware component. As such, the method 400 may issue API call for each of the member chassis in a stacked configuration in the same manner how the API call are issued to proxy monitored hardware components in the main chassis.

When the API calls have been issued to the controller devices in the chassis, they commence identifying their respective proxy monitored hardware components that are to be updated, any special operations to be performed on those proxy monitored hardware components, and begin downloading appropriate software package image 328 from the online support portal 326.

At any time during this process, the method 400 may receive a request to receive a status update according to user input at step 420. In such a case, the method 400 may issue a request to the controller device of each group for its update status.

When the controller device receives such a request, it may obtain various forms of status information, such as software update package download status, the status of any preliminary or post update scripts to be performed on the proxy monitored hardware components, and/or the general state of the proxy monitored hardware components at the present time. The controller device then sends such information to the method 400 in response to the request so that it can present the obtained information to the user, such as via the user interface 306 of the systems manager appliance 204.

At step 422, the method 400 triggers an update (i.e., installation) of hardware components using the software update packages that were downloaded as a result of the method 400 performing step 418. For example, steps 404-418 may be performed at any time during the operation of the computing environment, such as when it is in service during normal operation. The method 400 may use any suitable triggering event to commence installation of the software update packages. In one embodiment, the method 400 may be triggered after the systems manager 304 detects that all software update packages have been downloaded, and all preparatory operations completed. In another embodiment, the method 400 may be triggered in response to user input .

Such behavior may be useful in that, while downloading all software update packages may consume a relatively large amount of time due to various reasons (e.g., connectivity issues, online support portal availability, etc.), such activities may be coordinated at a time in which they do not adversely affect the operation of the computing environment to any excessive degree. When most or all software update packages have been successfully downloaded, the method 400 may be triggered (e.g., according to user input, etc.) to commence installing those software update packages at the same time so that the maintenance window in which the computing environment is out-of-service may be kept to a minimum level. Additionally, it may be important to note that step 420 may be performed to obtain a status of most or all of the trigger operation occurring on the proxy monitored hardware components while step 422 is currently being performed.

The aforedescribed method 400 may be performed each time certain hardware components of the computing environment are to be updated with new software. Nevertheless, when use of the software update method 400 is no longer needed or desired, the method 400 ends.

Although FIG. 4 describe one example of a process that may be performed to update proxy monitored hardware components in a computing environment, such as a stacked chassis architecture, the features of the disclosed processes may be embodied in other specific forms without deviating from the spirit and scope of the present disclosure. For example, certainly steps of the disclosed processes may be performed sequentially, or alternatively, they may be performed concurrently. As another example, the method 400 may perform additional, fewer, or different operations than those operations as described in the present example. As yet another example, certain steps of the process described herein may be performed by a computing system other than the systems manager appliance 204, such as by the processing environment provided by IHS 100 itself.

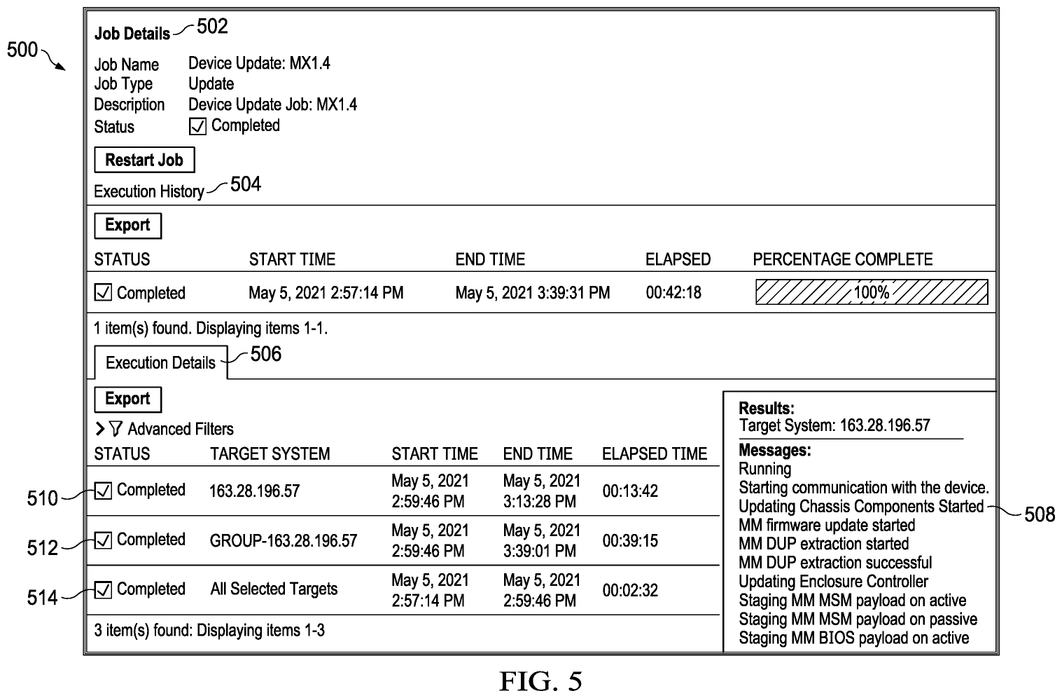

FIG. 5 illustrates an example status window 500 that may be generated by the systems manager 304 to display a status of a software update operation performed on a computing environment according to one embodiment of the present disclosure. In one embodiment, the status window 500 may be displayed as a result of performing step 420 by the method 400 of FIG. 4. In another embodiment, the status window 500 may be displayed on user interface 308 of the systems manager appliance 204 of FIG. 3. The status window 500 includes a job details window portion 502, an execution history window portion 504, an execution details window portion 506, and a results window portion 508.

The job details window portion 502 displays information associated with a job performed by the systems manager 304. In the particular example status window 500, the job details window portion 502 includes a ‘Job Name’ field, a ‘Job Type’ field, a Description' Field, and a ‘Job Status’ field indicating that an update job named MX1.4 has been performed and has been completed. The execution history window portion 504 includes a ‘status’ field, a ‘start time’ field, an ‘end time’ field, an ‘elapsed’ time field, and a ‘percentage complete’ field indicating, among other things, when the MX1.4 job was started and how long it required for completion.

The execution details window portion 506 includes a ‘status’ field, a ‘target system’ field, a “start time’ field, a ‘end time’ field, a ‘elapsed’ time field, and a ‘percentage complete’ field for each group of hardware components generated by the systems manager 304. For example, the execution detail window portion 506 is shown with a first record 510 for a target system named ‘100.69.124, 139’ that is associated with a controller device 320, a second record 512 for a target system named ‘GROUP-100.69.124, 139’ that is associated with one or more proxy monitored hardware components 318 controlled by the controller device 320, and a third record 514 for a target system named ‘All Selected Targets’ that displays cumulative information about all of the software updates job in progress. Thus as shown, the systems manager 304 may status information about the overall progress of a software update job as well as status information about how each group of hardware components are progressing.

Additionally, the status window 500 may display details about how specific update instructions are progressing for each group of hardware components. For example, the results window portion 508 displays specific instructions that are applied to the controller device 304 named ‘100.69.124.139.’ Thus, the user of the systems manager 304 may continually monitor how each update instructions is performed, and provide remediating actions if any of those update instructions fails or gets “stuck.”

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a plurality of hardware components comprising at least one directly managed hardware component;
a plurality of proxy managed hardware components;
one or more controller devices that are each configured to directly manage the proxy managed hardware devices via the directly managed hardware component; and
computer-readable instructions stored in at least one memory and executed by at least one processor to:
receive a request to perform a software update on the plurality of hardware components;
partition the directly managed hardware component from the proxy managed hardware components;
group the proxy managed hardware components according to each of the controller devices that directly manages the proxy managed components;
generate an Application Program Interface (API) call that specifies the group associated with each of the controller devices, wherein each group comprises a unique identifier (UID) for each proxy managed hardware component directly managed by its respective controller device; and
send the API call to the directly managed hardware component, wherein the directly managed hardware component is configured to communicate with each of the controller devices for updating the proxy managed hardware components according to the API call.

2. The IHS of claim 1, wherein the instructions are further executed to download a single update package image for the plurality of proxy managed hardware components.

3. The IHS of claim 1, wherein the instructions are further executed to download one or more update package images during a first time period, and install the downloaded update package images on the proxy monitored hardware components during a second time period after the first time period is completed.

4. The IHS of claim 3, wherein the instructions are further executed to trigger the second time period in response to at least one of detecting that all software update packages have been downloaded, and in response to user input .

5. The IHS of claim 1, wherein the instructions are further executed to:
perform a discovery operation to record information about the hardware components prior to receiving the request to perform the software update.

6. The IHS of claim 1, wherein the instructions are further executed to generate a second API call to perform a software update on the directly managed hardware component.

7. The IHS of claim 1, wherein the IHS comprises a modular chassis and the instructions are executed by a systems manager appliance.

8. The IHS of claim 1, wherein the IHS comprises a stacked configuration of a plurality of modular chassis including a main chassis and one or more member chassis, the member chassis comprising one of the proxy monitored hardware components.

9. The IHS of claim 1, wherein the API call is formatted as a tuple comprising a make and model of the hardware component and a unique identifier of each proxy monitored hardware component.

10. A method comprising:
receiving, using instructions stored in at least one memory and executed by at least one processor, a request to perform a software update on a plurality of hardware components comprising at least one directly managed hardware component and a plurality of proxy managed hardware components managed by one or more controller devices;
partitioning, using the instructions, the directly managed hardware component from the proxy managed hardware components;
grouping, using the instructions, the proxy managed hardware components according to each of the controller devices that directly manages the proxy managed components;
generating, using the instructions, an Application Program Interface (API) call that specifies the group associated with each of the controller devices, wherein each group comprises a unique identifier (UID) for each proxy managed hardware component directly managed by its respective controller device; and
sending, using the instructions, the API call to the directly managed hardware component, wherein the directly managed hardware component is configured to communicate with each of the controller devices for updating the proxy managed hardware components according to the API call.

11. The method of claim 1, further comprising downloading a single update package image for the plurality of proxy managed hardware components.

12. The method of claim 1, further comprising downloading one or more update package images during a first time period, and installing the downloaded update package images on the proxy monitored hardware components during a second time period after the first time period is completed.

13. The method of claim 3, further comprising triggering the second time period in response to at least one of detecting that all software update packages have been downloaded, and in response to user input .

14. The method of claim 1, further comprising performing a discovery operation to record information about the hardware components prior to receiving the request to perform the software update.

15. The method of claim 1, further comprising generating a second API call to perform a software update on the directly managed hardware component.

16. A systems manager appliance comprising:
computer-readable instructions stored in at least one memory and executed by at least one processor to:
receive a request to perform a software update on a plurality of hardware components comprising at least one directly managed hardware component and a plurality of proxy managed hardware components managed by one or more controller devices;
partition the directly managed hardware component from the proxy managed hardware components;
group the proxy managed hardware components according to each of the controller devices that directly manages the proxy managed components;
generate an Application Program Interface (API) call that specifies the group associated with each of the controller devices, wherein each group comprises a unique identifier (UID) for each proxy managed hardware component directly managed by its respective controller device; and
send the API call to the directly managed hardware component, wherein the directly managed hardware component is configured to communicate with each of the controller devices for updating the proxy managed hardware components according to the API call.

17. The systems manager appliance of claim 1, wherein the instructions are further executed to download a single update package image for the plurality of proxy managed hardware components.

18. The systems manager appliance of claim 1, wherein the instructions are further executed to download one or more update package images during a first time period, and install the downloaded update package images on the proxy monitored hardware components during a second time period after the first time period is completed.

19. The systems manager appliance of claim 1, wherein the instructions are further executed to trigger the second time period in response to at least one of detecting that all software update packages have been downloaded, and in response to user input.

20. The systems manager appliance of claim 1, wherein the instructions are further executed to perform a discovery operation to record information about the hardware components prior to receiving the request to perform the software update.
